(19) United States
(12) Patent Application Publication
(10) Pub. No.: US 2024/0359399 A1
(43) Pub. Date: Oct. 31, 2024

(54) PROCESS FOR PREPARING A MOLDED BODY BY SELECTIVE LASER SINTERING OF AN AMORPHOUS SINTERING POWDER (SP) WHICH CONTAINS POLYAMIDE 6I/6T AND/OR POLYAMIDE DT/DI

(71) Applicant: BASF SE, Ludwigshafen am Rhein (DE)

(72) Inventors: Claus GABRIEL, Ludwigshafen am Rhein (DE); Clemens GOTTKE, Ludwigshafen am Rhein (DE); Bernhard KREN, Ludwigshafen am Rhein (DE)

(21) Appl. No.: 18/682,617

(22) PCT Filed: Aug. 3, 2022
(86) PCT No.: PCT/EP2022/071860

§ 371 Date: Feb. 9, 2024

(30) Foreign Application Priority Data
Aug. 12, 2021 (EP) 21191097.1

(51) Int. Cl. B29C 64/153; B29C 64/268; B29C 64/314; B29K 77/00; B29K 105/00; B33Y 10/00; B33Y 40/10; B33Y 70/10

(52) U.S. Cl. CPC B29C 64/153; B29C 64/268; B29C 64/314; B29K 2077/00; B29K 2105/0044; B33Y 10/00; B33Y 40/10; B33Y 70/10

(57) ABSTRACT

The present invention relates to a method of producing a shaped body, wherein, in step i), a layer of an amorphous sinter powder (SP) comprising at least 70% by weight of at least one amorphous polyamide selected from the group consisting of polyamide 6I/6T and polyamide DT/DI is provided, and, in step ii), the layer provided in step i) is selectively sintered. The present invention further relates to a method of producing an amorphous sinter powder (SP) and to an amorphous sinter powder (SP) obtainable by that method. The present invention also relates to use of the amorphous sinter powder (SP) in a sintering method, and to shaped bodies obtainable by the method of the invention.

The present invention relates to a method of producing a shaped body, wherein, in step i), a layer of an amorphous sinter powder (SP) comprising at least 70% by weight of at least one amorphous polyamide selected from the group consisting of polyamide 6I/6T and polyamide DT/DI is provided, and, in step ii), the layer provided in step i) is selectively sintered. The present invention further relates to a method of producing an amorphous sinter powder (SP) and to an amorphous sinter powder (SP) obtainable by that method. The present invention also relates to use of the amorphous sinter powder (SP) in a sintering method, and to shaped bodies obtainable by the method of the invention.

The rapid provision of prototypes is a problem often addressed in recent times. One method which is particularly suitable for this “rapid prototyping” is selective laser sintering (SLS). This involves selectively exposing a plastic powder in a chamber to a laser beam. The powder melts; the molten particles coalesce and resolidify. Repeated application of plastic powder and subsequent exposure to a laser allows modeling of three-dimensional shaped bodies.

The method of selective laser sintering for producing shaped bodies from pulverulent polymers is described in detail in patent specifications U.S. Pat. No. 6,136,948 and WO 96/06881.

In selective laser sintering, it is customary to use semicrystalline polymers, since crystalline polymers have a sharp melting point. S. Kloos, M. A. Dechet, W. Peukert, J. Schmidt, Production of spherical semi-crystalline polycarbonate microparticles for Additive Manufacturing by liquid-liquid phase separation, Powder Technology 335 (2018) 275-284) describe the use of semicrystalline polyamides PA12, PA11 and PA6 for selective laser sintering. This further states that amorphous polycarbonates have poor processibility in selective laser sintering, and that the use of amorphous polycarbonates is very limited. Because of the amorphous nature of the polycarbonates, these are used solely in methods, for example fine casting methods, where dimensional accuracy of the shaped bodies produced is of minor importance.

In order to be able to use amorphous polycarbonates in selective laser sintering, S. Kloos, M. A. Dechet, W. Peukert, J. Schmidt, Production of spherical semi-crystalline polycarbonate microparticles for Additive Manufacturing by liquid-liquid phase separation, Powder Technology 335 (2018) 275-284) describe a modification process in which the amorphous polycarbonates are converted to semicrystalline polycarbonates.

J.-P. Kruth, G. Levy, F. Klocke, T. H. C. Childs, Consolidation phenomena in laser and powder-bed based layered manufacturing, Annals of the CIRP Vol. 56/2 (2007) 730-759, describe the fundamental properties of semicrystalline and amorphous polymers for laser sintering. It is pointed out therein that the sintering characteristics of amorphous polymers are generally poor. Sintered components made from amorphous polymers are described as porous and have poor mechanical properties.

U.S. Ser. No. 10/500,763B2 and US2020/0048481A1 likewise describe the use of originally amorphous polycarbonates in laser sintering processes, in which sinterability is achieved by converting the amorphous polycarbonate to a semicrystalline polycarbonate by suitable methods. U.S. Ser. No. 10/500,763B2 and US2020/0048481A1 likewise point out that the use of amorphous polymers in laser sintering processes is difficult since the methods have poor reproducibility, and the shaped bodies obtained have poor mechanical properties and low dimensional accuracy.

None of the documents cited describes the use of amorphous polyamides in selective laser sintering.

WO 2018/019728 A1 discloses a method of producing a shaped body by selective laser sintering of a sinter powder (SP). The sinter powder (SP) comprises at least one semicrystalline polyamide, at least one polyamide 6I/6T and at least one reinforcer.

WO 2018/019727 A1 likewise discloses a method of producing a shaped body by selective laser sintering of a sinter powder (SP). The sinter powder (SP) comprises at least one semicrystalline polyamide and at least one polyamide 6I/6T.

EP 3 491 065 B1 likewise discloses a method of producing a shaped body by selective laser sintering of a sinter powder (SP). The sinter powder (SP) comprises at least one semicrystalline polyamide and at least one polyamide 6I/6T, and at least one polyaryl ether.

WO 2019/224016 A1 discloses a method of forming a polymeric article by additive manufacturing, which provides means of forming articles at a low processing temperature, wherein the articles produced show high dimensional stability.

It is thus an object of the present invention to provide a method of producing shaped bodies by selective laser sintering which has the aforementioned disadvantages of the processes described in the prior art only to a reduced degree, if at all. The process should additionally be performable in a simple and inexpensive manner.

This object is achieved by a method of producing a shaped body by selective laser sintering, comprising the steps of:
i) providing a layer of an amorphous sinter powder (SP) comprising the following components
   (A) an amorphous polymer component comprising, based on the total weight of the amorphous polymer component, at least 70% by weight of at least one amorphous polyamide selected from the group consisting of polyamide 6I/6T and polyamide DT/DI,
   (B) optionally at least one additive and
   (C) optionally at least one reinforcer,
ii) laser-sintering the layer provided in step i), where the energy density (E_{V}) based on volume in step ii) is at least 1000 mJ/mm³, where the energy density (E_{V}) based on volume is calculated by the following formula:

$${E}_{V} = \frac{n \cdot P}{ν \cdot h \cdot d} [ \frac{J}{{mm}^{3}} ]$$

in which
P is the laser power of the laser used in step ii) in watts,
v is the scan speed of the laser used in step ii) in m/s,
h is the scan spacing in mm in step ii),
d is the layer thickness of the layer provided in step i) in mm and
n is the number of laser scans conducted in step ii),
where the following laser sintering parameters are applicable to steps i) and ii):
P is in the range from 15 to 40 watts,
v is in the range from 2 to 10 m/s,
h is in the range from 0.05 to 0.3 mm,
d is in the range from 0.03 to 0.15 mm and
n is in the range from 1 to 3.

It has been found that, surprisingly, amorphous sinter powders (SP) comprising an amorphous polymer component which, based on the total weight of the amorphous polymer component, at least 70% by weight of at least one amorphous polyamide selected from the group consisting of polyamide 6I/6T and polyamide DT/DI can be used in methods of selective laser sintering.

Shaped bodies that have been produced by the method of the invention have good mechanical properties. Shaped bodies that have been produced by the method of the invention additionally have constant mechanical properties over a wide temperature range. The method of the invention can additionally be conducted in standard laser sintering systems and in equipment including the relatively new desktop machines in which lasers having shorter wavelengths are used and which are operated at limited build space temperature. Shaped bodies that have been produced by the method of the invention show a good barrier to oxygen, carbon dioxide and moisture. They additionally have good solvent stability to aliphatic and aromatic hydrocarbons.

The process of the invention is elucidated in detail hereinafter.

### Step i)

In step i), a layer of the amorphous sinter powder (SP) is provided.

The layer of the sinter powder (SP) can be provided by any methods known to those skilled in the art. Typically, the layer of the sinter powder (SP)

is provided in a build space on a build platform. The temperature of the build space may optionally be controlled.

The build space, for example, is at a temperature in the range from 1 to 20 K (kelvin), preferably in the range from 1 to 15 K and more preferably in the range from 1 to 10 K above the glass transition temperature (Tg) of the amorphous polyamide 6I/6T or of the amorphous polyamide DT/DI, preferably above the glass transition temperature (Tg) of the amorphous polymer component and more preferably above the glass transition temperature (Tg) of the amorphous sinter powder (SP).

The build space, for example, is at a temperature in the range from 125 to 164° C., preferably in the range from 125 to 159° C. and especially preferably in the range from 125 to 154° C.

The build space, for PA 6I/6T, for example, is at a temperature in the range from 125 to 145° C., preferably in the range from 125 to 140° C. and especially preferably in the range from 125 to 135° C.

The build space, for PA DT/DI, for example, is at a temperature in the range from 144 to 164° C., preferably in the range from 144 to 159° C. and especially preferably in the range from 144 to 154° C.

The layer of the amorphous sinter powder (SP) can be provided in method step i) by any methods known to those skilled in the art. For example, the layer of the amorphous sinter powder (SP) is provided by means of a coating bar or a roll in the thickness to be achieved in the build space.

The layer thickness (d) of the layer of the amorphous sinter powder (SP) which is provided in step i) is generally in the range from 0.03 to 0.15 mm, preferably in the range from 0.04 to 0.13 mm and especially preferably in the range from 0.05 to 0.11 mm.

### Amorphous Sinter Powder (SP)

According to the invention, the amorphous sinter powder (SP) comprises an amorphous polymer component as component (A), optionally at least one additive as component (B), and optionally at least one reinforcer as component (C).

In the context of the present invention, the terms “component (A)” and “an amorphous polymer component” are used synonymously and therefore have the same meaning.

The same applies to the terms “component (B)” and “at least one additive”. These terms are likewise used synonymously in the context of the present invention and therefore have the same meaning.

Correspondingly, the terms “component (C)” and “at least one reinforcer” are also used synonymously in the context of the present invention and have the same meaning.

The amorphous sinter powder (SP) may comprise components (A), and optionally (B) and (C), in any desired amounts.

For example, the amorphous sinter powder (SP) comprises in the range from 50% to 100% by weight of component (A), in the range from 0% to 50% by weight of component (B) and in the range from 0% to 50% by weight of component (C), based in each case on the sum total of the percentages by weight of components (A) and optionally (B) and (C), preferably based on the total weight of the amorphous sinter powder (SP).

The present invention therefore also provides a process in which the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP).

The percentages by weight of components (A) and optionally (B) and (C) typically add up to 100% by weight.

The amorphous sinter powder (SP) comprises particles. These particles have, for example, a size in the range from 10 to 250 μm, preferably in the range from 15 to 200 μm, more preferably in the range from 20 to 120 μm and especially preferably in the range from 20 to 110 μm.

The amorphous sinter powder (SP) of the invention has, for example,
a D10 in the range from 10 to 60 μm,
a D50 in the range from 25 to 90 μm and
a D90 in the range from 50 to 150 μm.

Preferably, the amorphous sinter powder (SP) of the invention has
a D10 in the range from 20 to 50 μm,
a D50 in the range from 40 to 80 μm and
a D90 in the range from 80 to 125 μm.

The present invention therefore also provides a process in which the sinter powder (SP) has
a D10 in the range from 10 to 60 μm,
a D50 in the range from 25 to 90 μm and
a D90 in the range from 50 to 150 μm.

In the context of the present invention, the “D10” is understood to mean the particle size at which 10% by volume of the particles based on the total volume of the particles are smaller than or equal to the D10 and 90% by volume of the particles based on the total volume of the particles are larger than the D10. By analogy, the “D50” is understood to mean the particle size at which 50% by volume of the particles based on the total volume of the particles are smaller than or equal to the D50 and 50% by volume of the particles based on the total volume of the particles are larger than the D50. Correspondingly, the “D90” is understood to mean the particle size at which 90% by volume of the particles based on the total volume of the particles are smaller than or equal to the D90 and 10% by volume of the particles based on the total volume of the particles are larger than the D90.

To determine the particle sizes, the amorphous sinter powder (SP) is suspended in a dry state using compressed air or in a solvent, for example water or ethanol, and this suspension is analyzed. The D10, D50 and D90 are determined by means of laser diffraction using a Malvern MasterSizer 3000. Evaluation is by means of Fraunhofer diffraction.

The amorphous sinter powder (SP) preferably does not have a melting point. The sinter powder (SP) also preferably does not have a crystallization temperature (Tc).

“Amorphous” in the context of the present invention means that the amorphous sinter powder (SP) does not have any melting point in differential scanning calorimetry (DSC) measured according to ISO 11357.

“No melting point” means that the enthalpy of fusion of the amorphous sinter powder (SP) ΔH2_{(SP)} is less than 10 J/g, preferably less than 8 J/g and especially preferably less than 5 J/g, in each case measured by means of differential scanning calorimetry (DSC) according to ISO 11357-4:2014.

The amorphous sinter powder (SP) of the invention thus typically has an enthalpy of fusion ΔH2_{(SP)} of less than 10 J/g, preferably of less than 8 J/g and especially preferably of less than 5 J/g, in each case measured by means of differential scanning calorimetry (DSC) according to ISO 11357-4:2014.

The amorphous sinter powder (SP) of the invention typically has a glass transition temperature (T_{G(SP)}), where the glass transition temperature (T_{G(SP)}) is typically in the range from 90 to 150° C., preferably in the range from 92 to 148° C. and especially preferably in the range from 94 to 146° C., determined by means of ISO 11357-2:2014.

The amorphous sinter powder (SP) can be produced by any methods known to those skilled in the art. For example, the sinter powder is produced by grinding or by precipitation.

If the sinter powder (SP) is produced by precipitation, it is customary first of all to mix the amorphous polymer component (A) or constituents thereof and any additions and/or additives with a solvent and to dissolve the amorphous polymer component or constituents thereof in the solvent, optionally while heating, to obtain a solution. The sinter powder (SP) is subsequently precipitated, for example by cooling the solution, distilling the solvent out of the solution or adding a precipitant to the solution.

The grinding can be conducted by any methods known to those skilled in the art; for example, components (A) and optionally (B) and (C) are introduced into a mill and ground therein.

Suitable mills include all mills known to those skilled in the art, for example classifier mills, opposed jet mills, hammer mills, ball mills, vibratory mills or rotor mills such as pinned disk mills and whirlwind mills.

The grinding in the mill can likewise be effected by any methods known to those skilled in the art. For example, the grinding can take place under inert gas and/or while cooling with liquid nitrogen. Cooling with liquid nitrogen is preferred. The temperature in the grinding is as desired; the grinding is preferably performed at liquid nitrogen temperatures, for example at a temperature in the range from −210 to −195° C. The temperature of the components on grinding in that case is, for example, in the range from −40 to −30° C.

Preferably, the components are first mixed with one another and then ground. The method of producing the sinter powder (SP) in that case preferably comprises the steps of
a) mixing components (A) and optionally (B) and (C)
b) grinding the mixture obtained in step a) to obtain the sinter powder (SP).

The present invention therefore also provides a method of producing an amorphous sinter powder (SP), comprising the steps of
a) mixing the following components:
   (A) an amorphous polymer component comprising, based on the total weight of the amorphous polymer component, at least 70% by weight of at least one amorphous polyamide selected from the group consisting of polyamide 6I/6T and polyamide DT/DI,
   (B) optionally at least one additive and
   (C) optionally at least one reinforcer,
b) grinding the mixture obtained in step a) to obtain the sinter powder (SP).

Processes for compounding (for mixing) in step a) are known as such to those skilled in the art. For example, the mixing can be effected in an extruder, especially preferably in a twin-screw extruder.

In respect of the grinding in step b), the details and preferences described above are correspondingly applicable with regard to the grinding.

The present invention therefore also further provides the sinter powder (SP) obtainable by the method of the invention.

### Component (A)

Component (A) is an amorphous polymer component comprising, based on the total weight of the amorphous polymer component, at least 70% by weight of at least one amorphous polyamide selected from the group consisting of polyamide 6I/6T and polyamide DT/DI.

In the context of the present invention, the term “polyamide 6I/6T” means either exactly one polyamide 6I/6T or a mixture of two or more different polyamides 6I/6T. Component (A) preferably comprises exactly one polyamide 6I/6T.

In the context of the present invention, the term “polyamide DT/DI” means either exactly one polyamide DT/DI or a mixture of two or more different polyamides DT/DI. Component (A) preferably comprises exactly one polyamide DT/DI.

“Amorphous” in the context of the present invention means that the amorphous polymer component (component (A)) does not have any melting point in differential scanning calorimetry (DSC) measured according to ISO 11357.

“No melting point” means that the enthalpy of fusion of the amorphous polymer component ΔH2_{(A)} is less than 10 J/g, preferably less than 8 J/g and especially preferably less than 5 J/g, in each case measured by means of differential scanning calorimetry (DSC) according to ISO 11357-4:2014.

Suitable amorphous polymer components thus typically have an enthalpy of fusion ΔH2_{(A)} of less than 10 J/g, preferably of less than 8 J/g and especially preferably of less than 5 J/g, in each case measured by means of differential scanning calorimetry (DSC) according to ISO 11357-4:2014.

Component (A) of the invention typically has a glass transition temperature (T_{G}(A)), where the glass transition temperature (T_{G}(A)) is typically in the range from 90 to 150° C., preferably in the range from 92 to 148° C. and especially preferably in the range from 94 to 146° C., determined by means of ISO 11357-2:2014.

The polyamide 6I/6T used in accordance with the invention typically has a glass transition temperature (T_{G(6I/6T)}), where the glass transition temperature (T_{G(6I/6T)}) is typically in the range from 120 to 130° C., preferably in the range from 122 to 129° C. and especially preferably in the range from 123 to 128° C., determined by means of ISO 11357-2:2014.

The polyamide DT/DI used in accordance with the invention typically has a glass transition temperature (T_{G(DT/DI)}), where the glass transition temperature (T_{G(DT/DI)}) is typically in the range from 140 to 150° C., preferably in the range from 141 to 148° C. and especially preferably in the range from 142 to 147° C., determined by means of ISO 11357-2:2014.

Suitable polyamides 6I/6T may comprise any desired proportions of 6I and 6T structural units. Preferably, the molar ratio of 6I structural units to 6T structural units is in the range from 1:1 to 3:1, more preferably in the range from 1.5:1 to 2.5:1 and especially preferably in the range from 1.8:1 to 2.3:1.

The MVR (275° C./5 kg) (melt volume flow rate) of suitable polyamides 6I/6T is preferably in the range from 10 mL/10 min to 200 mL/10 min, more preferably in the range from 40 mL/10 min to 150 mL/10 min.

The zero shear rate viscosity no of suitable polyamides 6I/6T at 240° C. is, for example, in the range from 300 to 5000 Pas, preferably in the range from 500 to 3500 Pas. Zero shear rate viscosity no is determined with a “DHR-1” rotary viscometer from TA Instruments and a plate-plate geometry with a diameter of 25 mm and a plate separation of 1 mm. Samples of polyamide 6I/6T are dried at 80° C. under reduced pressure for 7 days and these are then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Suitable polyamides 6I/6T have, for example, an amino end group concentration (AEG) which is preferably in the range from 30 to 50 mmol/kg and especially preferably in the range from 35 to 45 mmol/kg.

For determination of the amino end group concentration (AEG), 1 g of the polyamide 6I/6T is dissolved in 30 mL of a phenol/methanol mixture (volume ratio of phenol:methanol 75:25) and then subjected to potentiometric titration with 0.2 N hydrochloric acid in water.

Suitable polyamides 6I/6T have, for example, a carboxyl end group concentration (CEG) which is preferably in the range from 60 to 155 mmol/kg and especially preferably in the range from 80 to 135 mmol/kg.

For determination of the carboxyl end group concentration (CEG), 1 g of the polyamide 6I/6T is dissolved in 30 mL of benzyl alcohol. This is followed by visual titration at 120° C. with 0.05 N potassium hydroxide solution in water.

Suitable polyamides DT/DI may comprise any desired proportions of DT and DI structural units. Preferably, the molar ratio of DT structural units to DI structural units is in the range from 1:1 to 3:1, more preferably in the range from 1.5:1 to 2.5:1 and especially preferably in the range from 1.8:1 to 2.3:1.

The zero shear rate viscosity no of suitable polyamides DT/DI at 240° C. is, for example, in the range from 500 to 10000 Pas, preferably in the range from 1000 to 5000 Pas. Zero shear rate viscosity no is determined with a “DHR-1” rotary viscometer from TA Instruments and a plate-plate geometry with a diameter of 25 mm and a plate separation of 1 mm. Samples of polyamide DT/DI are dried at 80° C. under reduced pressure for 7 days and these are then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Suitable polyamides DT/DI have, for example, an amino end group concentration (AEG) which is preferably in the range from 20 to 60 mmol/kg and especially preferably in the range from 25 to 50 mmol/kg.

For determination of the amino end group concentration (AEG), 1 g of the polyamide DT/DI is dissolved in 30 mL of a phenol/methanol mixture (volume ratio of phenol:methanol 75:25) and then subjected to potentiometric titration with 0.2 N hydrochloric acid in water.

Suitable polyamides DT/DI have, for example, a carboxyl end group concentration (CEG) which is preferably in the range from 60 to 155 mmol/kg and especially preferably in the range from 80 to 135 mmol/kg.

For determination of the carboxyl end group concentration (CEG), 1 g of the polyamide DT/DI is dissolved in 30 mL of benzyl alcohol. This is followed by visual titration at 120° C. with 0.05 N potassium hydroxide solution in water.

Polyamide DT/DI derives from the monomers isophthalic acid, terephthalic acid and 2-methylpentamethylenediamine, and is sold by suppliers including Shakespeare under the Novadyn® DT/DI trade name.

The polymer component (component (A)) may, as well as polyamide 6I/6T and/or polyamide DT/DI, based on the total weight of the polymer component, comprise up to 30% by weight of at least one polymer (P) other than polyamide 6I/6T and polyamide DT/DI.

In the context of the present invention, “at least one polymer (P)” means either exactly one polymer (P) or a mixture of two or more polymers (P).

In one embodiment, component (A) thus comprises at least 70% by weight of at least one amorphous polyamide selected from the group consisting of polyamide 6I/6T and polyamide DT/DI, and 0% to 30% by weight of at least one polymer (P), based in each case on the total weight of component (A).

In a further preferred embodiment, component (A) consists of at least one polyamide selected from the group consisting of polyamide 6I/6T and polyamide DT/DI.

It will be clear to a person skilled in the art that, if the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP), and component (A) consists of at least one polyamide selected from the group consisting of polyamide 6I/6T and polyamide DT/DI, the sinter powder (SP) comprises 50% to 100% by weight of polyamide 6I/6T and/or polyamide DT/DI, based on the total weight of the amorphous sinter powder (SP).

The present invention therefore also provides a process in which the sinter powder (SP) comprises 50% to 100% by weight of polyamide 6I/6T and/or polyamide DT/DI, based on the total weight of the amorphous sinter powder (SP).

In a further preferred embodiment, component (A) consists of polyamide 6I/6T.

It will likewise be clear to a person skilled in the art that, if the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP), and component (A) consists of polyamide 6I/6T, the sinter powder (SP) comprises 50% to 100% by weight of polyamide 6I/6T, based on the total weight of the amorphous sinter powder (SP).

The at least one polymer (P), if present, may take the form of a blend or powder mixture in component (A). The at least one polymer (P), if present, preferably takes the form of a blend in component (A).

The at least one polymer (P) is preferably a polyamide other than polyamide 6I/6T and polyamide DT/DI. The polyamide may be amorphous or semicrystalline.

The polymer (P) may, for example, be an amorphous semiaromatic polyamide other than polyamide 6I/6T and polyamide DT/DI. Amorphous semiaromatic polyamides of this kind are known to those skilled in the art and are selected, for example, from the group consisting of PA 6I, PA 6/3T and PA PACM12.

The polymer (P) may, for example, also be a semicrystalline polyamide. In this embodiment, the polymer (P) preferably takes the form of a blend with polyamide 6I/6T and/or polyamide DT/DI, such that component (A) does not have a melting point.

“Semicrystalline” in the context of the present invention means that the polymer (P) has an enthalpy of fusion ΔH2_{(P)} of greater than 45 J/g, preferably of greater than 50 J/g and especially preferably of greater than 55 J/g, in each case measured by means of differential scanning calorimetry (DSC) according to ISO 11357-4:2014.

Suitable semicrystalline polyamides are, for example, semicrystalline polyamides that derive from lactams having 4 to 12 ring members. Also suitable are semicrystalline polyamides that are obtained by reaction of dicarboxylic acids with diamines. Examples of at least one lactam-derived semicrystalline polyamide include polyamides that derive from polycaprolactam, polycaprylolactam and/or polylaurolactam.

If a semicrystalline polyamide obtainable from dicarboxylic acids and diamines is used, dicarboxylic acids used may be alkanedicarboxylic acids having 6 to 12 carbon atoms. Aromatic dicarboxylic acids are also suitable.

Examples of dicarboxylic acids here include adipic acid, azelaic acid, sebacic acid and dodecanedicarboxylic acid.

Examples of suitable diamines include alkanediamines having 4 to 12 carbon atoms and aromatic or cyclic diamines, for example m-xylylenediamine, di(4-aminophenyl)methane, di(4-aminocyclohexyl)methane, 2,2-di(4-aminophenyl)propane or 2,2-di(4-aminocyclohexyl)propane.

Preferred semicrystalline polyamides are polycaprolactam (nylon-6) and nylon-6/6,6 copolyamide. Nylon-6/6,6 copolyamide preferably has a proportion of 5% to 95% by weight of caprolactam units, based on the total weight of the nylon-6/6,6 copolyamide.

Also suitable as semicrystalline polyamide are polyamides obtainable by copolymerization of two or more of the monomers mentioned above and below or mixtures of a plurality of polyamides in any desired mixing ratio. Particular preference is given to mixtures of nylon-6 with other polyamides, especially nylon-6/6,6 copolyamide.

Further preferred semicrystalline polyamides are nylon-6,6 and nylon-6,10.

The nonexhaustive list that follows comprises the aforementioned polyamides and further suitable polyamides that can be used as polymer (P) and are different from polyamide 6I/6T and polyamide DT/DI, and the monomers present.

### Ab Polymers:

PA 4 pyrrolidone
PA 6 ε-caprolactam
PA 7 enantholactam
PA 8 caprylolactam
PA 9 9-aminopelargonic acid
P 11 11-aminoundecanoic acid
P 12 laurolactam

### Aa/Bb Polymers:

PA 46 tetramethylenediamine, adipic acid
PA 66 hexamethylenediamine, adipic acid
PA 69 hexamethylenediamine, azelaic acid
PA 610 hexamethylenediamine, sebacic acid
PA 612 hexamethylenediamine, decanedicarboxylic acid
PA 613 hexamethylenediamine, undecanedicarboxylic acid
PA 1212 dodecane-1,12-diamine, decanedicarboxylic acid
PA 1313 1,13-diaminotridecane, undecanedicarboxylic acid
PA 6T hexamethylenediamine, terephthalic acid
PA MXD6 m-xylylenediamine, adipic acid
PA 6/66 (see PA 6 and PA 66)
PA 6/12 (see PA 6 and PA 12)
PA 6/6.36 ε-caprolactam, hexamethylenediamine, C36 dimer acid
PA 6T/6 (see PA 6T and PA 6)

The polyamide (polymer (P)) other than polyamide 6I/6T and polyamide DT/DI is preferably selected from the group consisting of PA 4, PA 6, PA 7, PA 8, PA 9, PA 11, PA 12, PA 46, PA 66, PA 69, PA 6.10, PA 6.12, PA 6.13, PA 6/6.36, PA 6T/6, PA 12.12, PA 13.13, PA 6T, PA MXD6, PA 6/66, PA 6/12 and copolyamides of these.

Most preferably, the polyamide (polymer (P)) other than polyamide 6I/6T and polyamide DT/DI is selected from the group consisting of nylon-6, nylon-12 and nylon-6/6,6, and also nylon-6,10 and nylon-6,6.

### Component (B)

Component (B) is at least one additive.

In the context of the present invention, “at least one additive” means either exactly one additive or a mixture of two or more additives.

Additives as such are known to those skilled in the art. For example, the at least one additive is selected from the group consisting of stabilizers, conductive additives, end group functionalizers, dyes, color pigments and flame retardants.

The present invention therefore also provides a method in which component (B) is selected from the group consisting of stabilizers, conductive additives, end group functionalizers, dyes, color pigments and flame retardants.

Suitable stabilizers are, for example, phenols, phosphites and copper stabilizers. Suitable conductive additives are carbon fibers, metals, stainless steel fibers, carbon nanotubes and carbon black. Suitable end group functionalizers are, for example, terephthalic acid, adipic acid and propionic acid. Suitable dyes and color pigments are, for example, carbon black and iron chromium oxides.

If the sinter powder comprises component (B), it comprises at least 0.1% by weight of component (B), preferably at least 50% by weight of component (B), based on the sum total of the percentages by weight of components (A), (B) and optionally (C), preferably based on the total weight of the sinter powder (SP).

Suitable flow aids are, for example, silicas or aluminas. A preferred flow aid is alumina. An example of a suitable alumina is Aeroxide® Alu C from Evonik.

Preference is given to flame retardants that give off water at elevated temperatures. Preferred mineral flame retardants are therefore aluminum hydroxide and/or magnesium hydroxide and/or aluminum oxide hydroxide. Magnesium hydroxide is particularly preferred as mineral flame retardant.

The mineral flame retardant may also be used, for example, in mineral form. An example of a suitable mineral is boehmite. Boehmite has the chemical composition AlO(OH) or γ-AlOOH (aluminum oxide hydroxide).

Aluminum hydroxide is also referred to as ATH or aluminum trihydroxide. Magnesium hydroxide is also referred to as MDH or magnesium dihydroxide.

The flame retardant has, for example, a D10 in the range from 0.3 to 1.2 μm, a D50 in the range from 1.2 to 2 μm and a D90 in the range from 2 to 5 μm.

Preferably, the flame retardant has a D10 in the range from 0.5 to 1 μm, a D50 in the range from 1.3 to 1.8 μm and a D90 in the range from 2 to 4 μm.

The D10, D50 and D90 are determined as described above for the D10, D50 and D90 of the sinter powder (SP).

The flame retardant may additionally have been surface-modified. For example, the flame retardant has been aminosilane-modified.

### Component (C)

According to the invention, component (C) is at least one reinforcer.

In the context of the present invention, “at least one reinforcer” means either exactly one reinforcer or a mixture of two or more reinforcers.

In the context of the present invention, a reinforcer is understood to mean a material that improves the mechanical properties of shaped bodies produced by the process of the invention compared to shaped bodies that do not comprise the reinforcer.

Reinforcers as such are known to those skilled in the art. Component (C) may, for example, be in spherical form, in platelet form or fibrous form.

Preferably, the at least one reinforcer is in platelet form or in fibrous form.

A “fibrous reinforcer” is understood to mean a reinforcer in which the ratio of length of the fibrous reinforcer to the diameter of the fibrous reinforcer is in the range from 2:1 to 40:1, preferably in the range from 3:1 to 30:1 and especially preferably in the range from 5:1 to 20:1, where the length of the fibrous reinforcer and the diameter of the fibrous reinforcer are determined by microscopy by means of image evaluation on samples after ashing, with evaluation of at least 70 000 parts of the fibrous reinforcer after ashing.

The length of the fibrous reinforcer in that case is typically in the range from 5 to 1000 μm, preferably in the range from 10 to 600 μm and especially preferably in the range from 20 to 500 μm, determined by means of microscopy with image evaluation after ashing.

The diameter in that case is, for example, in the range from 1 to 30 μm, preferably in the range from 2 to 20 μm and especially preferably in the range from 5 to 15 μm, determined by means of microscopy with image evaluation after ashing.

In a further preferred embodiment, the at least one reinforcer is in platelet form. In the context of the present invention, “in platelet form” is understood to mean that the particles of the at least one reinforcer have a ratio of diameter to thickness in the range from 4:1 to 10:1, determined by means of microscopy with image evaluation after ashing.

Suitable reinforcers are known to those skilled in the art and are selected, for example, from the group consisting of carbon nanotubes, carbon fibers, boron fibers, glass fibers, glass beads, silica fibers, ceramic fibers, basalt fibers, aluminosilicates, aramid fibers and polyester fibers.

The at least one reinforcer is preferably selected from the group consisting of aluminosilicates, glass fibers, glass beads, silica fibers and carbon fibers.

The at least one reinforcer is more preferably selected from the group consisting of aluminosilicates, glass fibers, glass beads and carbon fibers. These reinforcers may additionally have been aminosilane-functionalized.

Suitable silica fibers are, for example, wollastonite.

Suitable aluminosilicates are known as such to the person skilled in the art.

Aluminosilicates refer to compounds comprising Al₂O₃ and SiO₂. In structural terms, a common factor among the aluminosilicates is that the silicon atoms are tetrahedrally coordinated by oxygen atoms and the aluminum atoms are octahedrally coordinated by oxygen atoms. Aluminosilicates may additionally comprise further elements.

Preferred aluminosilicates are sheet silicates. Particularly preferred aluminosilicates are calcined aluminosilicates, especially preferably calcined sheet silicates. The aluminosilicate may additionally have been aminosilane-functionalized.

If the at least one reinforcer is an aluminosilicate, the aluminosilicate may be used in any form. For example, it can be used in the form of pure aluminosilicate, but it is likewise possible that the aluminosilicate is used in mineral form. Preferably, the aluminosilicate is used in mineral form. Suitable aluminosilicates are, for example, feldspars, zeolites, sodalite, sillimanite, andalusite and kaolin. Kaolin is a preferred aluminosilicate.

Kaolin is one of the clay rocks and comprises essentially the mineral kaolinite. The empirical formula of kaolinite is Al₂[(OH)₄/Si₂O₅]. Kaolinite is a sheet silicate. As well as kaolinite, kaolin typically also comprises further compounds, for example titanium dioxide, sodium oxides and iron oxides. Kaolin preferred in accordance with the invention comprises at least 98% by weight of kaolinite, based on the total weight of the kaolin.

If the sinter powder comprises component (C), it comprises at least 1% by weight of component (C), based on the sum total of the percentages by weight of components (A) and optionally (B) and/or (C), preferably based on the total weight of the sinter powder (SP).

### Step ii)

In step ii), the layer of the sinter powder (SP) provided in step i) is exposed.

On exposure, at least some of the layer of the sinter powder (SP) becomes free-flowing. The liquefied sinter powder (SP) coalesces. After the exposure, the liquefied portion of the layer of the sinter powder (SP) cools down again and solidifies again.

Suitable methods of exposure include all methods known to those skilled in the art. Preferably, the exposure in step ii) is effected with a radiation source. The radiation source is preferably a laser.

Suitable lasers are known to those skilled in the art and are, for example, fiber lasers, Nd:YAG lasers (neodymium-doped yttrium aluminum garnet lasers), carbon dioxide lasers or diode lasers.

If the radiation source used in the exposing in step ii) is a laser, the layer of the sinter powder (SP) provided in step i) is typically exposed locally and briefly to the laser beam. This selectively renders only the parts of the sinter powder (SP) that have been exposed to the laser beam free-flowing. This method is also referred to as selective laser sintering. Selective laser sintering is known per se to those skilled in the art.

It has been found that, surprisingly, when the laser sintering parameters of the invention in method step ii) are observed, shaped bodies having good mechanical properties and only low discoloration, if any, are obtained. The shaped bodies additionally have relatively uniform mechanical properties over a wide temperature range.

In the laser sintering of the layer provided in step i), the volume-based energy density (E_{V}) in step ii), according to the invention, is at least 1000 mJ/mm³.

According to the invention, the volume-based energy density (E_{V}) is calculated by the following formula:

$${E}_{V} = \frac{n \cdot P}{ν \cdot h \cdot d} [ \frac{J}{{mm}^{3}} ]$$

In the formula:
P is the laser power of the laser used in step ii) in watts,
v is the scan speed of the laser used in step ii) in m/s,
h is the scan spacing in mm in step ii),
d is the layer thickness of the layer provided in step i) in mm and
n is the number of laser scans conducted in step ii).

In a preferred embodiment, the volume-based energy density (E_{V}) in step ii) is in the range from 1000 to 3000 mJ/mm³, more preferably in the range from 1100 to 2750 mJ/mm³ and especially preferably in the range from 1200 to 2600 mJ/mm³.

The power P of the laser used in method step ii) is in the range from 15 to 40 watts, preferably in the range from 20 to 35, more preferably in the range from 22 to 32 watts and especially preferably in the range from 23 to 30 watts.

The scan speed v in method step ii) is in the range from 1 to 15 m/s, preferably in the range from 2 to 12 m/s, more preferably in the range from 3 to 10 m/s and especially preferably in the range from 4 to 8 m/s.

The scan spacing h in method step ii) is in the range from 0.05 to 0.3 mm, preferably in the range from 0.07 to 0.25 mm, more preferably in the range from 0.08 to 0.2 mm and especially preferably in the range from 0.08 to 0.18 mm.

Scan spacing h is also known as laser spacing or lane spacing. Selective laser sintering typically involves scanning in stripes. The scan spacing gives the distance between the centers of the stripes, i.e. between the two centers of the laser beam for two stripes.

The number of laser scans n in method step ii) is in the range from 1 to 3, where n is preferably 1 or 2 and n is most preferably 2.

After step ii), the layer of the sinter powder (SP) is typically lowered by the layer thickness of the layer of the sinter powder (SP) provided in step i) and a further layer of the sinter powder (SP) is applied. This is subsequently exposed again in step ii).

This firstly bonds the upper layer of the sinter powder (SP) to the lower layer of the sinter powder (SP); in addition, the particles of the sinter powder (SP) within the upper layer are bonded to one another by liquefaction.

In the process according to the invention, steps i) and ii) can thus be repeated.

By repeating the lowering of the powder bed, the applying of the sinter powder (SP) and the exposure and hence the liquefying of the sinter powder (SP), three-dimensional shaped bodies are produced. It is possible to produce shaped bodies that also have cavities, for example. No additional support material is necessary since the unmolten sinter powder (SP) itself acts as a support material.

The present invention therefore also further provides a shaped body obtainable by the method of the invention.

The present invention therefore also provides for the use of a sinter powder (SP) comprising the following components:
(A) an amorphous polymer component comprising, based on the total weight of the amorphous polymer component, 70% by weight of at least one amorphous polyamide selected from the group consisting of polyamide 6I/6T and polyamide DT/DI,
(B) optionally at least one additive and
(C) optionally at least one reinforcer,
   in a sintering process.

### Shaped Bodies

The method of the invention affords a shaped body. The shaped body can be removed from the powder bed directly after the solidification of the sinter powder (SP) liquefied on exposure in step ii). It is likewise possible first to cool the shaped body and only then to remove it from the powder bed. Any adhering particles of the sinter powder that have not been liquefied can be mechanically removed from the surface by known methods.

Methods for surface treatment of the shaped body include, for example, vibratory grinding or barrel polishing, and also sandblasting, glass bead blasting or microbead blasting.

It is also possible to subject the shaped bodies obtained to further processing or, for example, to treat the surfaces.

The present invention therefore further provides a shaped body obtainable by the method of the invention.

The shaped bodies obtained typically comprise in the range from 50% to 100% by weight of component (A), in the range from 0% to 50% by weight of component (B), in the range from 0% to 50% by weight of component (C), based in each case on the total weight of the shaped body.

According to the invention, component (A) is the component (A) that was present in the sinter powder (SP). Component (B), if present, is likewise the component (B) that was present in the sinter powder (SP), and component (C), if present, is likewise the component (C) that was present in the sinter powder (SP).

It will be clear to the person skilled in the art that, as a result of the exposure of the sinter powder (SP), components (A) and optionally (B) and (C) can enter into chemical reactions and can be altered as a result. Such reactions are known to those skilled in the art.

Preferably, components (A) and optionally (B) and (C) do not enter into any chemical reaction on exposure in step ii); instead, the sinter powder (SP) merely becomes free-flowing.

The invention is elucidated in detail hereinafter by examples, without restricting it thereto.

### EXAMPLES

The following components are used:
Amorphous polymer components (components (A)) used are Grivory G16 (amorphous polyamide 6I/6T) from EMS, Zytel HTN 301 (amorphous polyamide 6I/6T) from DuPont, and Novadyn DT/DI (amorphous polyamide DT/DI) from Shakespeare (US).

Component (B) used is Irganox® 1098 (N,N′-hexane-1,6-diylbis(3-(3,5-di-tert-butyl-4-hydroxyphenylpropionamide))) from BASF SE.

Semicrystalline polyamides used are Ultrasint® PA6 (polyamide PA6) from BASF 3D Printing Solutions GmbH, Heidelberg, and Ultramid® B27E (polyamide PA6) from BASF SE.

Amorphous sinter powders (SP) used are Grivory G16, Zytel HTN 301, Ultrasint® PA6, and a mixture of Grivory G16 with Ultramid® B27 and Irganox® 1098 (mixing ratio: 74.6% by weight, 25% by weight, 0.4% by weight).

TABLE 1
Characteristic data of the polymers

| | | | | MVR |
|---|---|---|---|---|
| | | | Zero shear | (275° C., |
| | Tₘ₂, | T_{g2}, | viscosity η₀ at | 5 kg) |
| Polymer | [° C.] | [° C.] | 240° C. [Pas] | [cm³/10 min] |
| Grivory G16 | — | 124 | 580 | 143 |
| Zytel HTN 301 | — | 127 | 2450 | 44 |
| Novadyn | — | 143 | 2700 | |
| DT/DI | | | | |
| Ultrasint ® | 218 | 66 | 530 | |
| PA6 | | | | |

Melting point Tₘ₂ [° C.], glass transition temperature T_{g2} [° C.] and zero shear viscosity η₀ at 240° C. [Pas] are determined as described above.

TABLE 2
Characterization of powder properties

| | Bulk | Tamped | | | | |
|---|---|---|---|---|---|---|
| | density, | density, | Hausner | d₁₀, | d₅₀, | d₉₀, |
| Polymer powder | kg/m³ | kg/m³ | factor | μm | μm | μm |
| Grivory G16 | 477 | 602 | 1.26 | 18.4 | 42 | 76 |
| Zytel HTN 301 | 422 | 586 | 1.39 | 23 | 49 | 85 |
| Ultrasint ® PA6 | 471 | 538 | 1.14 | 39 | 62 | 97 |

### Sintering Characteristics

Sintering experiments were conducted on a standard Farsoon HT251P SLS system (carbon dioxide laser wavelength 10.6 μm).

The sintering characteristics of amorphous PA 6I6T, using the example of Grivory G16, were examined in detail by SLS parameter study on Farsoon HT251P (tab. 3); the results for Zytel HTN 301 (AP2) are given in table 4.

TABLE 3
Parameter study on the sintering characteristics of Grivory G16. Mechanical component characterization
by determination of flexural modulus and observations on discoloration of sintered components.
The discoloration of the sintered components was assessed visually by the following criteria:

| | Laser | | Scan | Layer | | Volume-based | | |
|---|---|---|---|---|---|---|---|---|
| | power | Number | spacing | thickness | Powder bed | energy density | Flexural | Discoloration |
| | (P) | of scans | (h) | (d) | temperature | (E_{V}) | modulus | of sintered |
| No. | [W] | (n) | [mm] | [mm] | [° C.] | [mJ/mm³] | [MPa] | component |
| 1 | 23 | 1 | 0.18 | 0.1 | 135 | 259 | 252 | low |
| 2 | 50 | 1 | 0.18 | 0.1 | 135 | 556 | 1314 | severe |
| 3 | 60 | 1 | 0.18 | 0.1 | 135 | 667 | 1659 | severe |
| 4 | 70 | 1 | 0.18 | 0.1 | 135 | 778 | 1770 | severe |
| 5 | 55 | 1 | 0.12 | 0.1 | 135 | 917 | 1861 | severe |
| 6 | 70 | 1 | 0.12 | 0.1 | 135 | 1167 | 1961 | severe |
| 7 | 35 | 1 | 0.12 | 0.05 | 132 | 1167 | 1670 | low |
| 8 | 45 | 1 | 0.12 | 0.05 | 132 | 1500 | 1907 | severe |
| 9 | 55 | 1 | 0.12 | 0.05 | 132 | 1833 | 2024 | severe |
| 10 | 65 | 1 | 0.12 | 0.05 | 132 | 2167 | 2139 | severe |
| 11 | 45 | 2 | 0.12 | 0.05 | 132 | 3000 | 2073 | severe |
| 12 | 55 | 2 | 0.12 | 0.05 | 132 | 3667 | 1799 | very severe |
| 13 | 65 | 2 | 0.12 | 0.05 | 132 | 4333 | 1652 | very severe |
| 14 | 14 | 2 | 0.12 | 0.05 | 132 | 933 | 748 | very low |
| 15 | 21 | 2 | 0.12 | 0.05 | 132 | 1400 | 1606 | low |
| 16 | 28 | 2 | 0.12 | 0.05 | 132 | 1867 | 2255 | low |
| 17 | 35 | 2 | 0.12 | 0.05 | 132 | 2333 | 2254 | low |

TABLE 4
Parameter study on the sintering characteristics of Zytel HTN301. Mechanical component characterization
by determination of flexural modulus and observations on discoloration of sintered components

| | Laser | | Scan | Layer | | Volume-based | | |
|---|---|---|---|---|---|---|---|---|
| | power | Number | spacing | thickness | Powder bed | energy density | Flexural | Discoloration |
| | (P) | of scans | (h) | (d) | temperature | (Ev) | modulus | of sintered |
| No. | [W] | (n) | [mm] | [mm] | [° C.] | [mJ/mm³] | [MPa] | component |
| 1 | 45 | 2 | 0.12 | 0.05 | 128 | 3000 | 1693 | severe |
| 2 | 21 | 2 | 0.12 | 0.05 | 128 | 1400 | 1038 | low |
| 3 | 28 | 2 | 0.12 | 0.05 | 128 | 1867 | 1442 | low |
| 4 | 35 | 2 | 0.12 | 0.05 | 128 | 2333 | 1505 | low |
| 5 | 60 | 1 | 0.12 | 0.05 | 128 | 2000 | 1841 | very severe |
| 6 | 45 | 2 | 0.12 | 0.05 | 130 | 3000 | 1639 | severe |
| 7 | 21 | 2 | 0.12 | 0.05 | 130 | 1400 | 1151 | low |
| 8 | 28 | 2 | 0.12 | 0.05 | 130 | 1867 | 1603 | low |
| 9 | 35 | 2 | 0.12 | 0.05 | 130 | 2333 | 1652 | low |

The scan speed (v) of the laser in all cases is 5 m/s.

The mechanical tests were conducted by a 3-point bending test at room temperature. The testing instrument was a Stable Micro Systems TA-HD plus. The tests were effected at room temperature. The test specimens were tested without further pretreatment after sintering. Test specimen: width 10 mm, length 80 mm, thickness 4 mm, support spacing 64 mm. Speeds: 0.1 mm/s for determination of modulus, 0.3 mm/s for other measurements

The volume-based energy density during laser sintering is calculated as follows:

$${E}_{V} = \frac{n \cdot P}{ν \cdot h \cdot d} [ \frac{J}{{mm}^{3}} ]$$

In this formula, P is the laser power [W], v is the scan speed of the laser [m/s], h is the scan spacing [mm], d is the layer thickness [mm] and n is the number of laser scans. The area-based energy density is obtained from the volume-based energy density by multiplication by the layer thickness.

TABLE 5
SLS sinter parameters for various polymers. For Grivory G16, further laser powers/energy
densities were tested and components were tested in a tensile test by standard methods.

| | Powder bed | Ram | Cylinder | | Laser | Scan | Scan | Number | Layer | Energy |
|---|---|---|---|---|---|---|---|---|---|---|
| | temperature | temperature | temperature | Powder | power P | speed v | spacing | of | thickness | density |
| Polymer | [° C.] | [° C.] | [° C.] | reservoir | [W] | [m/s] | [mm] | scans | [μm] | [J/mm³] |
| Grivory G16 | 132 | 128 | 128 | 110 | 25 | 5 | 0.12 | 2 | 50 | 1.67 |
| Zytel HTN 301 | 130 | 115 | 115 | 100 | 28 | 5 | 0.12 | 2 | 50 | 1.87 |
| Ultrasint PA 6 | 200 | 180 | 180 | 145 | 50 | 15 | 0.18 | 1 | 100 | 0.19 |

### Component Characterization

### Mechanical Properties at Room Temperature

The sintering parameters shown in tab. 5 were used to produce test specimens for mechanical tests, which were tested in a standard manner. Results in tab. 6.

TABLE 6
Characterization of the mechanical properties by tensile test according
to ISO 527-2:2012 at room temperature (23° C.) and Charpy
impact resistance test according to DIN EN ISO179-2: 2012.

| | | | | Impact | |
|---|---|---|---|---|---|
| | Tensile | Tensile | Elongation | resistance | Discoloration |
| | modulus | strength | at break | aCU | of sintered |
| | N/mm² | N/mm² | % | kJ/m² | component |
| Grivory G16 (dry) | 2340 | 44 | 2.3 | 9 | low |
| Grivory G16 | 2250 | 49 | 4.2 | — | low |
| (conditioned) | | | | | |
| Zytel HTN301 (dry) | 1930 | 43 | 2.9 | 11 | low |
| Ultrasint ® PA 6 (dry) | 3500 | 61 | 2 | 7 | low |
| Ultrasint ® PA 6 | 1600 | 54 | 51 | — | low |
| (conditioned) | | | | | |

“Dry” means storage at 80° C. under reduced pressure for 336 hours.
“Conditioned” means storage at 70° C. and relative air humidity 72% for 336 hours.

Table 6 shows that the amorphous polyamides PA 6I6T (Grivory G16 and Zytel HTN301) with the claimed process parameters of laser sintering achieve good mechanical properties overall and have only low discoloration of the components.

Change in Mechanical Properties with Temperature

Storage modulus G′ was measured by dynamic-mechanical analysis (DMTA) within a temperature range from −100° C. to 200° C. For the temperature ranges specified in table 7, the change in storage modulus G′ was evaluated over the respective temperature range. For this purpose, the storage modulus G′ at the highest temperature in the respective temperature range was subtracted from the value of the storage modulus G′ at the lowest temperature, and this difference was normalized to the temperature interval. The specified temperature ranges cover typical ranges of application temperature.

| DMTA test instrument: | Rheometrics RDA 1 | |
|---|---|---|
| Test conditions: | | |
| Standard | ISO 6721-7 | |
| Temperature ramp | 1 | K/min |
| Temperature | −100° C. to 200° C. (under nitrogen) | |
| Frequency | 1 | Hz |
| Initial strain | 0.2% | |
| Geometry | 40 mm × 10 mm × 4 mm | |
| Test specimen length | 60 | mm |

TABLE 7
Change in storage modulus G′ in Pa/K within the respectively
specified temperature range from mechanical-dynamic measurement by DMTA

| | ΔG′/DT (Pa/K) | ΔG′/DT (Pa/K) | ΔG′/DT (Pa/K) |
|---|---|---|---|
| | Temperature range | Temperature range | Temperature range |
| Polymer | −30° C.-30° C. | 20° C.-80° C. | 20° C.-120° C. |
| Grivory G16 | 1.1E+06 | 6.7E+05 | 2.0E+06 |
| Ultrasint ® PA6 | 1.3E+06 | 1.3E+07 | 1.2E+07 |

It is a feature of polyamide 6I6T that the change in the modulus over a given temperature range is small compared to other materials that are used in SLS methods, for example Ultrasint® PA 6. For PA 6, especially in the temperature ranges of 20° C. to 80° C. and 20° C. to 120° C., the changes in the modulus are several factors higher than is the case for PA 6I6T.

### Mixtures of Amorphous Polyamide PA 6I6T and Semicrystalline Polyamide PA 6

A mixture of Grivory G16 with Ultramid® B27 and Irganox® 1098 (mixing ratio: 74.6% by weight, 25% by weight, 0.4% by weight) was produced.

Composition of the mixture of PA 6I6T and PA 6 (produced in a twin-screw extruder with screw diameter 25 mm. The screw speed is 200 l/min, the throughput 20 kg/h, and the housing temperature established in the ejection zone 280° C. The resulting pressure at the extrusion nozzle of diameter 4 mm is 10 bar):

| | | |
|---|---|---|
| PA 6I6T | Grivory G16 natur | 74.6% by weight |
| PA 6 | Ultramid B27E | 25% by weight |
| Stabilizer | Irganox 1098 | 0.4% by weight |

The sinter powder was produced by grinding the mixture.

It has been found that mixtures of PA 6I6T with 25% by weight of PA 6 can be processed and likewise achieve good component properties.

### Material Analyses:

TABLE 8
Characteristic data of the polymers

| | | | | | Zero shear viscosity η₀ |
|---|---|---|---|---|---|
| Polymer | Tₘ₂, ° C. | ΔH₂, J/g | Tₖ, ° C. | T_{g2}, ° C. | at 240° C. [Pas] |
| Grivory G16 | — | — | — | 124 | 580 |
| Ultramid B27E | 220 | 79 | 184 | 53 | 362 |
| nylon-6 | | | | | |
| Mixture | 214 | 1 | — | 94 | 665 |
| PA 6I6T/PA 6 | | | | | |
| 75/25 | | | | | |

Because of the very low enthalpy of fusion in the second heating run (heating rate 20 K/min), the mixture can be regarded as effectively amorphous. In the cooling run (cooling rate 20 K/min), no crystallization is observed, which should thus be considered to mean no crystallization temperature either.

TABLE 9
Powder analyses

| | Bulk | Tamped | | | | |
|---|---|---|---|---|---|---|
| | density, | density, | Hausner | d₁₀, | d₅₀, | d₉₀, |
| Experiment | kg/m³ | kg/m³ | factor | μm | μm | μm |
| Grivory G16 | 477 | 602 | 1.26 | 18.4 | 42 | 76 |
| Mixture PA 6I6T/ | 485 | 555 | 1.14 | 38 | 62 | 101 |
| PA 6 75/25 | | | | | | |

TABLE 10
Laser sintering parameters; variation in laser power.

| | | Powder bed | Ram | Cylinder | | Laser | Scan | Scan | Number | Layer | Energy |
|---|---|---|---|---|---|---|---|---|---|---|---|
| Sintering | | temperature | temperature | temperature | Powder | power P | speed v | spacing | of | thickness | density |
| experiment | Polymer | [° C.] | [° C.] | [° C.] | reservoir | [W] | [m/s] | [mm] | scans | [μm] | [J/mm³] |
| 1 | Grivory G16 | 132 | 128 | 128 | 110 | 14 | 5 | 0.12 | 2 | 50 | 0.93 |
| 2 | Grivory G16 | 132 | 128 | 128 | 110 | 21 | 5 | 0.12 | 2 | 50 | 1.4 |
| 3 | Grivory G16 | 132 | 128 | 128 | 110 | 25 | 5 | 0.12 | 2 | 50 | 1.67 |
| 4 | Grivory G16 | 132 | 128 | 128 | 110 | 35 | 5 | 0.12 | 2 | 50 | 2.33 |
| 5 | Mixture PA 6I6T/ | 124 | 100 | 100 | 60 | 38 | 5 | 0.12 | 2 | 50 | 2.53 |
| | PA 6 75/25 | | | | | | | | | | |

TABLE 11
Component properties, test in the dry state at 23° C., depending on energy density (see tab. 10)

| | | | | | Impact | | |
|---|---|---|---|---|---|---|---|
| | | Tensile | Tensile | Elongation | resistance | HDT | Discoloration |
| Sintering | | modulus | strength | at break | aCU | A/B | of sintered |
| experiment | | N/mm² | N/mm² | % | kJ/m² | ° C. | component |
| 1 | Grivory G16 | 560 | 10 | 4 | 5 | 92/95 | low |
| 2 | Grivory G16 | 1490 | 34 | 3.8 | 9 | 108/105 | low |
| 3 | Grivory G16 | 2340 | 44 | 2.3 | 9 | 108/114 | low |
| 4 | Grivory G16 | 2400 | 46 | 2.1 | 14 | 107/113 | low |
| 5 | Mixture PA 6I6T/ | 2780 | 44 | 1.6 | 7 | 103/111 | low |
| | PA 6 75/25 | | | | | | |

1.-13. (canceled)

14. A method for producing a shaped body by selective laser sintering, comprising the steps of:
i) providing a layer of an amorphous sinter powder (SP) comprising the following components
(A) an amorphous polymer component comprising, based on the total weight of the amorphous polymer component, at least 70% by weight of at least one amorphous polyamide selected from the group consisting of polyamide 6I/6T and polyamide DT/DI,
(B) optionally at least one additive and
(C) optionally at least one reinforcer,
ii) laser-sintering the layer provided in step i), where the energy density (E_{V}) based on volume in step ii) is at least 1000 mJ/mm³, where the energy density (E_{V}) based on volume is calculated by the following formula:
$${E}_{V} = \frac{n \cdot P}{v \cdot h \cdot d} [ \frac{J}{{mm}^{3}} ]$$
in which
P is the laser power of the laser used in step ii) in watts,
v is the scan speed of the laser used in step ii) in m/s,
h is the scan spacing in mm in step ii),
d is the layer thickness of the layer provided in step i) in mm and
n is the number of laser scans conducted in step ii),
where the following laser sintering parameters are applicable to steps i) and ii):
P is in the range from 15 to 40 watts,
v is in the range from 2 to 10 m/s,
h is in the range from 0.05 to 0.3 mm,
d is in the range from 0.03 to 0.15 mm and
n is in the range from 1 to 3, where
the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP).

15. The method according to claim 14, wherein the amorphous sinter powder (SP) comprises particles having a size in the range from 10 to 250 μm.

16. The method according to claim 14, wherein the amorphous sinter powder (SP) has
a D10 in the range from 10 to 60 μm,
a D50 in the range from 25 to 90 μm and
a D90 in the range from 50 to 150 μm.

17. The method according to claim 14, wherein component (B) is selected from the group consisting of stabilizers, conductive additives, end group functionalizers, dyes, color pigments and flame retardants.

18. The method according to claim 14, wherein component (C) is selected from the group consisting of carbon nanotubes, carbon fibers, boron fibers, glass fibers, glass beads, silica fibers, ceramic fibers, basalt fibers, aluminosilicates, aramid fibers and polyester fibers.

19. A method of producing an amorphous sinter powder (SP) according to claim 14, comprising the steps of
a) mixing the following components:
(A) an amorphous polymer component comprising, based on the total weight of the amorphous polymer component, at least 70% by weight of at least one amorphous polyamide selected from the group consisting of polyamide 6I/6T and polyamide DT/DI,
(B) optionally at least one additive and
(C) optionally at least one reinforcer,
b) grinding the mixture obtained in step a) to obtain the sinter powder (SP), where
the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP).

20. An amorphous sinter powder (SP) obtainable by a method according to claim 19.

21. The use of an amorphous sinter powder (SP) comprising the following components:
(A) an amorphous polymer component comprising, based on the total weight of the amorphous polymer component, at least 70% by weight of at least one amorphous polyamide selected from the group consisting of polyamide 6I16T and polyamide DT/DI,
(B) optionally at least one additive and
(C) optionally at least one reinforcer,
in a sintering method, where
the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP).

22. A shaped body obtainable by a method according to claim 14, wherein the shaped body obtained comprises in the range from 50% to 100% by weight of component (A), in the range from 0% to 50% by weight of component (B), in the range from 0% to 50% by weight of component (C), based in each case on the total weight of the shaped body.

23. An amorphous sinter powder (SP) comprising the following components:
(A) an amorphous polymer component comprising, based on the total weight of the amorphous polymer component, at least 70% by weight of at least one amorphous polyamide selected from the group consisting of polyamide 6I16T and polyamide DT/DI,
(B) optionally at least one additive and
(C) optionally at least one reinforcer, where
the amorphous sinter powder (SP) comprises in the range from 50% to 100% by weight of component (A), in the range from 0% to 50% by weight of component (B) and in the range from 0% to 50% by weight of component (C), based in each case on the total weight of the amorphous sinter powder (SP).

24. The amorphous sinter powder (SP) according to claim 23, which comprises particles having a size in the range from 10 to 250 μm.

25. The amorphous sinter powder (SP) according to claim 23, which has
a D10 in the range from 10 to 60 μm,
a D50 in the range from 25 to 90 μm and
a D90 in the range from 50 to 150 μm.
